(19) United States
(12) Patent Application Publication
(10) Pub. No.: US 2015/0100289 A1
(43) Pub. Date: Apr. 9, 2015

(54) METHOD AND SYSTEM FOR SHAPEWISE COMPARISON

(71) Applicant: Technion Research & Development Foundation Limited, Haifa (IL)

(72) Inventors: Ron KIMMEL, Haifa (IL); Yonathan AFLALO, Tel-Aviv (IL); Anastasia DUBROVINA, Haifa (IL)

(21) Appl. No.: 14/508,051

(22) Filed: Oct. 7, 2014

Related U.S. Application Data
(60) Provisional application No. 61/888,603, filed on Oct. 9, 2013.

(51) Int. Cl. G06F 17/50

(52) U.S. Cl. CPC G06F 17/5009
USPC 703/2

(57) ABSTRACT

A method of determining correspondence between non-planar surfaces is disclosed. The method comprises calculating, for each surface, a spectral representation based on an eigenbasis of at least a portion of the surface; calculating a mapping matrix, based on the spectral representations; and determining the correspondence between the non-planar surfaces, based on the mapping matrix and the eigenbases.

### RELATED APPLICATION

This application claims the benefit of priority under 35 USC 119(e) of U.S. Provisional Patent Application No. 61/888,603 filed on Oct. 9, 2013, the contents of which are incorporated herein by reference in their entirety.

### FIELD AND BACKGROUND OF THE INVENTION

The present invention, in some embodiments thereof, relates to applied geometry and, more particularly, but not exclusively, to a method and system for shapewise comparison.

Matching of surfaces has recently become an important task of computer vision and is needed in a variety of applications. Humans have a remarkable ability to identify objects in a rapid and seemingly effortless fashion. It develops over several years of childhood and results in the intelligence to recognize thousands of objects throughout our lifetime. This skill is quite robust, and allows humans to correctly identify others despite changes in appearance, like aging, hairstyle, facial hair and expression.

Matching solvers for rigid surfaces in three-dimensions are known as iterative closest point algorithms or ICP. Non-rigid matching usually involves much more dimensions that can add up to the number of points of the sampled surfaces that one wishes to match. When ignoring the continuity and thus smoothness of matching one surface to another, the problem can be viewed as a combinatorial one, for which the computational complexity is exponential. The problem in this setting is NP hard, which is the hardest to solve in terms of computational complexity.

Various attempts to define robust and invariant meaningful measures by which articulated objects and deformable shapes could be identified were made. Adopting tools from metric geometry, the Gromov-Hausdorff distance and its variants were suggested as candidates for measuring the discrepancy between two deformable shapes [Facundo Memoli, On the use of Gromov-Hausdorff distances for shape comparison, In M. Botsch, R. Pajarola, B. Chen, and M. Zwicker, editors, Symposium on Point Based Graphics, pages 81-90, Prague, Czech Republic, 2007; Bronstein et al., Generalized multidimensional scaling: A framework for isometry-invariant partial surface matching, Proceedings of the National Academy of Sciences of the United States of America, 103(5):1168-1172, 2006].

Other intermediate embedding spaces for matching non-rigid shapes were also advocated. The eigenspace of the Laplace-Baltrami operator was suggested as potential Euclidean target space [Mateus et al., Articulated shape matching using laplacian eigenfunctions and unsupervised point registration, IEEE Conference on Computer Vision and Pattern Recognition, 2008, pages 1-8].

Also known is the use of permuted sparse coding, where the dense correspondence is extracted through coupling the functional map representation with that of matching corresponding regions. In this technique, the computation is performed by alternating minimization over the unknown functional map, while penalizing non-diagonal solutions, and a permutation matrix, representing the correspondences [Pokrass et al., Sparse modeling of intrinsic correspondences, Computer Graphics Forum (EUROGRAPHICS), 32:459-268, 2013].

Additional background art includes: Berard et al., Embedding riemannian manifolds by their heat kernel, Geometric and Functional Analysis, 4(4):373-398, 1994; R. R. Coifman and S. Lafon, Diffusion maps, Applied and Computational Harmonic Analysis, 21(1):5-30, 2006, Special Issue: Diffusion Maps and Wavelets; Bruno Levy, Laplace-Beltrami eigenfunctions towards an algorithm that “understands” geometry, IEEE International Conference on Shape Modeling and Applications, 2006, page 13; Gu et al., Genus zero surface conformal mapping and its application to brain surface mapping, IEEE Transactions on Medical Imaging, 23(8):949-958, 2004; Jin et al., Optimal global conformal surface parameterization, In Visualization, 2004, IEEE, pages 267-274; and Zeng et al., Computing quasiconformal maps using an auxiliary metric and discrete curvature flow, Numerische Mathematik, 121(4):671-703, 2012.

### SUMMARY OF THE INVENTION

According to an aspect of some embodiments of the present invention there is provided a method of determining correspondence between non-planar surfaces. The method comprises: using a data processor for calculating, for each surface, a spectral representation based on an eigenbasis of at least a portion of the surface; using the data processor for calculating a mapping matrix, based on the spectral representations; using the data processor for determining the correspondence between the non-planar surfaces, based on the mapping matrix and the eigenbases, and for displaying the correspondence and/or storing the correspondence on a non-volatile computer readable medium.

According to some embodiments of the invention wherein at least one of the non-planar surfaces is characterized by a dissimilarity matrix, and wherein the calculation of the spectral representation is also based on the dissimilarity matrix.

According to some embodiments of the invention the method comprises calculating the dissimilarity matrix.

According to some embodiments of the invention the invention the method comprises calculating the eigenbasis.

According to some embodiments of the invention the first and the second surfaces are surfaces of an organism at different poses.

According to some embodiments of the invention the first and the second surfaces are surfaces of an organ of a human or an animal at different poses.

According to some embodiments of the invention the first and the second surfaces are surfaces of macromolecules.

According to an aspect of some embodiments of the present invention there is provided a computer software product. The computer software product comprises a non-volatile computer-readable medium in which program instructions are stored, which instructions, when read by a data processor, cause the data processor to calculate, for each surface, a spectral representation based on an eigenbasis of at least a portion of the surface; to calculate a mapping matrix based on the spectral representations; to determine the correspondence between the non-planar surfaces, based on the mapping matrix and the eigenbases, and to display the correspondence and/or recording the correspondence on a non-volatile computer readable medium.

According to an aspect of some embodiments of the present invention there is provided a system for determining correspondence between non-planar surfaces. The system comprises a data processor configured for receiving coordinates of the surfaces, for calculating, for each surface, a spectral representation based on an eigenbasis of at least a portion of the surface; for calculating a mapping matrix, based on the spectral representations; for determining the correspondence between the non-planar surfaces, based on the mapping matrix and the eigenbases, and for displaying the correspondence and/or recording the correspondence on a non-volatile computer readable medium.

According to some embodiments of the invention the system at least one of the non-planar surfaces is characterized by a dissimilarity matrix, wherein the calculation of the spectral representation is also based on the dissimilarity matrix.

According to some embodiments of the invention the data processor is configured for calculating the dissimilarity matrix.

According to some embodiments of the invention the calculation of the dissimilarity matrix comprises calculating a dissimilarity measure between every two points of the at least a portion of the surface.

According to some embodiments of the invention the system wherein the dissimilarity measure comprises a geodesic distance over the surface.

According to some embodiments of the invention the system wherein the calculation of the spectral representation comprises applying an optimization procedure to traces of matrices obtained by transformations of an eigenbasis matrix describing the eigenbasis by a spectral representation matrix describing the spectral representation.

According to some embodiments of the invention the calculation of the mapping matrix, comprises applying an optimization procedure to a trace of a matrix constructed from the mapping matrix and from spectral representation matrices describing the spectral representations of the first and the second surfaces.

According to some embodiments of the invention the data processor is configured for calculating the eigenbasis.

According to some embodiments of the invention the eigenbasis matrix is a Laplacian eigenbasis.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart diagram of a method suitable for determining correspondence between non-planar surfaces, according to some embodiments of the present invention;

FIG. 2 shows angles defined on a triangle mesh;

FIG. 3 is a schematic illustration of a data processing system according to some embodiments of the present invention;

FIGS. 4A-L show mapping functions between two almost isometric synthetic shapes of a man figure, as obtained in experiments performed according to some embodiments of the present invention;

FIGS. 5A-L show mapping functions between two almost isometric synthetic shapes of a cat figure, as obtained in experiments performed according to some embodiments of the present invention;

FIG. 6 shows dense point-to-point correspondence among six almost isometric shapes of a horse as obtained in experiments performed according to some embodiments of the present invention;

FIGS. 7A and 7B show quantitative evaluation of the technique of the present embodiments when applied to shapes from a dataset;

FIGS. 8A and 8B show mapping functions between two almost isometric noisy shapes as obtained in experiments performed according to some embodiments of the present invention using two image datasets; and

FIGS. 9A and 9B show performance evaluation (FIG. 9A) of the technique of the present embodiments compared to other methods applied to two “David” shapes (FIG. 9B).

### DESCRIPTION OF SPECIFIC EMBODIMENTS OF THE INVENTION

The present invention, in some embodiments thereof, relates to applied geometry and, more particularly, but not exclusively, to a method and system for shapewise comparison.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

While conceiving the present invention it has been hypothesized and while reducing the present invention to practice it has been realized that correspondence between non-planar surfaces can be determined by calculating a mapping matrix, based on spectral representations of the non-planar surfaces. The correspondence between non-planar surfaces is a measure that quantifies similarity between the shape of the surfaces or their non-rigid deformations. For example, the correspondence can be use to determine whether a shape of one non-planar surface is a non-rigid deformation of another non-planar surface. The correspondence can optionally and preferably be expressed as a matrix P whose matrix-element Pᵢⱼ represents the assignment or mapping of a point i of one surface to a point j in the other surface.

The term “non-planar surface” is typically known as a metric space (S, d_{S}) induced by a smooth connected and compact Riemannian 2-manifold S, characterized by a geodesic distance function d_{S}(sₐ,s_{b}) between every two points sₐ and s_{b} on S. The value of d_{S}(sₐ,s_{b}) is the length of the minimal geodesic of S which passes through the points sₐ and s_{b}.

It is recognized, however, that practically only a sampled version of the surface in known. Such a sampled surface is represented by a point-cloud which is a set of points sⱼ (j=1, . . . , N), on the Riemannian 2-manifold, and which is sufficient for describing the topology of the manifold. Being represented as a discrete set of points, the sampled version of the surface is characterized by a discrete set of geodesic distances, rather than by a continuous function. Such a discrete set of geodesic distances is conveniently described by a dissimilarity matrix D.

Thus, unless explicitly stated, the term “non-planar surface” refers herein to a sampled surface represented by an appropriate point-cloud. The term “surface” is used herein as an abbreviation of the term “non-planar surface”.

The metric tensor of the Riemannian 2-manifold is denoted by the upper case letter G. G defines distances on the manifold, scalar products between vectors or vector fields that are tangential to the manifold, and scalar products between functions that are defined on the manifold. The determinant of the metric tensor G is denoted by the lower-case letter g, and the discretization matrix of the square root of g is denoted A. For example, when the manifold represents a triangulated surface, A can be a diagonal matrix whose Aᵢᵢ element is the sum of areas of all triangles that share the surface vertex i.

Some of the operations for determining the correspondence between non-planar surfaces are matrix operations. Representative examples of operations include summation, multiplication, decomposition, transformation, and calculations of eigenvectors and eigenvalues. All these operations are well known to those skilled in the art of matrix operations. Herein, matrices are represented by bold letters.

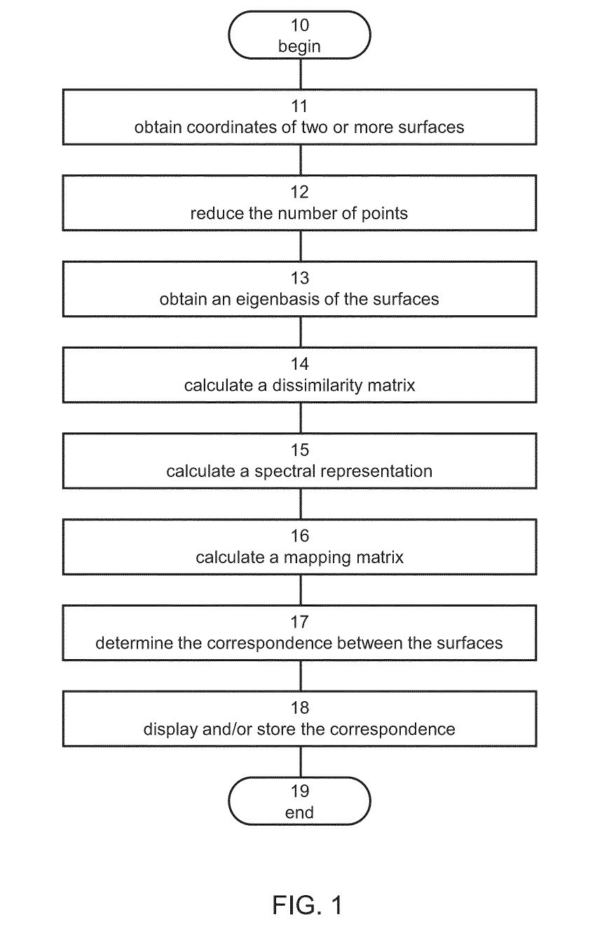

FIG. 1 is a flowchart diagram of a method suitable for determining correspondence between non-planar surfaces, according to some embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

The method can be embodied in many forms. For example, it can be embodied in on a tangible medium such as a computer for performing the method steps. It can be embodied on a computer readable medium, preferably a non-volatile computer readable medium, comprising computer readable instructions for carrying out the method steps. In can also be embodied in electronic device having digital computer capabilities arranged to run the computer program on the tangible medium or execute the instruction on a computer readable medium.

Computer programs implementing the method of the present embodiments can commonly be distributed to users over a communication network, such as the internet, or on a distribution medium such as, but not limited to, a CD-ROM or a flash drive. From the communication network or distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method of the present embodiments. All these operations are well-known to those skilled in the art of computer systems.

The method begins at 10 and continues to 11 at which the coordinates of the surfaces, or sampled versions thereof, are received. The surfaces can be surfaces of any object of interest, optionally and preferably a non-rigid or articulated object. Each of the surfaces can be a surface of an organism (human, animal, plant, bacteria, etc.), a surface of an organ of a human or animal, or of a macromolecule (e.g., a protein, a DNA, etc.). The surfaces can be surfaces of a human or animal at different poses, surfaces of different mutations of a plant or a bacterium, surfaces of a molecule and a modified molecule, and the like.

The surfaces can be obtained from another source (e.g., a computer readable medium) as sets of coordinates of points forming point clouds, or the coordinates can be extracted by the method, typically from images of the respective objects, as known in the art.

In some embodiments of the present invention, the method continues to 12 at which the number of points in at least one of the point clouds is reduced. This can be done using any sampling technique known in the art. In a preferred embodiment, the farthest point sampling method is employed [see, e.g., Dorit S Hochbaum and David B Shmoys, A best possible heuristic for the k-center problem, Mathematics of operations research, 10(2):180-184, 1985; and Teofilo F Gonzalez, Clustering to minimize the maximum intercluster distance, Theoretical Computer Science, 38:293-306, 1985]. The reduction is optionally and preferably performed so as to remove from about 70% to about 99%, or from about 80% to about 99%, or from about 90% to about 99%, e.g., about 95% of the points in the respective point cloud.

The method optionally continues to 13 at which an eigenbasis is obtained for each surface. The eigenbasis is obtained for all or a portion of the points obtained for the respective surface. When 12 is executed, the eigenbasis is preferably obtained using those points which remain after the reduction. Preferably the eigenbasis is a Laplacian eigenbasis. The eigenbasis can be expressed as an eigenbasis matrix Φ, whose ith column is the ith eigenfunction of some operator, for example, the Laplace operator. The eigenbasis can be calculated by the method or received as input from external source (e.g., user input).

In some embodiments of the present invention the columns of the eigenbasis matrix Φ are eigenfunction of the Laplace-Beltrami operator (LBO). The LBO is defined over a non-planar surface, and is generally defined as the divergence of the gradient of the surface. The LBO is typically expressed by means of a discretization matrix L. Typically, the diagonal of L is the negative sum of the off-diagonal elements of the corresponding row. Any discretization matrix can be used for constructing the Laplacian eigenbasis. In some embodiments of the present invention L satisfies the relation L=A⁻¹W, where W is a weight matrix.

In some embodiments, the weight matrix W is defined in terms of cotangent edge weights which are suitable for constructing a discrete LBO operator on a triangle mesh that discretized the manifold. Cotangent edge weights are weights that are assigned to the edges of the triangles of the meshes, and that are proportional to cotangents of angles between edges. The use of the cotangent function is particularly useful since it expresses the ratio between a scalar product and a vector product between two edges. Typically, an edge is assigned with a weight that is proportional to cotangents of angles between edges that share triangles with it. When an edge is on the boundary of the surface, it is associated with one angle and it can be assigned with a weight that is proportional to the cotangent of the angle against the edge at a vertex of the triangle opposite to the edge. When an edge is internal with respect to the boundary of the surface, it is associated with two triangles and it can be assigned with a weight that is proportional to the sum of cotangents of the angles against the edge at the vertices of the two triangles opposite to the edge.

A portion of a triangle mesh is illustrated in FIG. 2. An edge (ξ,η) is marked between two vertices ξ and η. The edge is illustrated as internal and is therefore shared by two triangles. In each triangle, there is a vertex that is opposite to edge (ξ,η). The angles against (ξ,η) at the two vertices opposite to (ξ,η) are denoted β_{ξη} and γ_{ξη}. Using these notations, the weight matrix W can be defined as:

$${W}_{ξ η} = \{ \begin{matrix}{\sum }_{{τ}_{( ξ , τ ) ∈ E}} ( cot {γ}_{ξ τ} + cot {β}_{ξ τ} ) & if ξ = η \\ - ( cot {γ}_{ξ η} + cot {β}_{ξ η} ) & if ξ \neq η , ( ξ , η ) ∈ E\end{matrix} \qquad EQ . 1$$

where E is the set of edges of the triangle mesh.

In some embodiments, the weight matrix W is the graph Laplacian, where the graph is constructed by connecting nearest neighbors. Graph Laplacian matrices are known in the art and found, for example, in Belkin et al., 2001, “Laplacian eigenmaps and spectral techniques for embedding and clustering,” Advances in Neural Information Processing Systems (MIT Press, Cambridge, Mass.), pp 585-591, the contents of which are hereby incorporated by reference.

Use of other discretization techniques, such as the Finite Elements Method is also contemplated.

Once the discretization matrix L of the LBO is obtained, the eigenvectors of L can be calculated and the matrix Φ can be constructed by setting its ith column to be its ith eigenvector. The obtained eigenbasis matrices are labeled herein by the subscripts “s”. Thus, for example, the eigenbasis matrix of a first surface is denoted Φ₁, the eigenbasis matrix of a second surface is denoted Φ₂, and the like. The set of matrices that are obtained at 12 is denoted collectively by Φₛ, where s is an integer larger than 1. The dimension of Φₛ is denoted Mₛ×Mₛ. The matrices Φₛ are preferably calculated by a data processor, at a rate of at least 10,000 or at least 20,000 or at least 40,000 or at least 80,000 or at least 160,000 or at least 320,000 or at least 640,000 matrix elements per second. Other rates are also contemplated. Typically, the value of M, is at least 200 or at least 400 or at least 800 or at least 1,600. Other values are also contemplated.

The method optionally and preferably continues to 14 at which a dissimilarity matrix D is obtained for each surface. The dissimilarity matrices can be calculated or they can be received from external source, such as, but not limited to, a computer readable medium.

A dissimilarity matrix is a matrix that describes the dissimilarities between the points on the surface. Each matrix element of D represents a dissimilarity measure between two points on the surface. In some embodiments of the present invention the dissimilarity measure between two points relates to a geodesic distance between the points. For example, the dissimilarity measure can be the square of the geodesic distance. The value of the geodesic distance between two points is the length of the minimal geodesic of the respective manifold which passes through the points.

The calculation of geodesic distance matrices is well known in the art. In some embodiments of the invention the calculation of D is performed using the fast marching method (FMM), found, e.g., in J. A. Sethian, “A fast marching level set method for monotonically advancing fronts,” Proc. Nat. Acad. Sci., 1996, 93(4): 1591-1595; and R. Kimmel and J. A. Sethian “Computing geodesic on manifolds,” Proc. US National Academy of Science, 1998, 95:8431-8435, the contents of which are hereby incorporated by reference. FMM is an efficient numerical method to compute a first-order approximation of the geodesic distances. Given a set of points on the manifold a distance map from these points to other points on the manifold is obtained as the solution of an Eikonal equation.

The method optionally and preferably continues to 15 at which a spectral representation is calculated for each surface. The spectral representation is typically expressed as a spectral representation matrix α where the subscript s identifies the respective surface. Specifically, α₁ denotes the spectral representation matrix of the first surface and α₂ denotes the spectral representation matrix of the second surface.

Each matrix αₛ is typically calculated based on the eigenbasis of the respective surface or a portion thereof, and optionally also based on the dissimilarity matrix of the surface. The matrices αₛ are referred to as “spectral representation matrices” because their matrix-elements are calculated using the eigenvalues of the operator used to construct the eigenbasis, which can be viewed as a set of frequencies in a spectral decomposition. The dimensions of the matrices αₛ are preferably the same as the dimensions of Φₛ.

In some embodiments of the present invention the calculation of αₛ comprises an optimization procedure applied to the traces of the matrices αₛ^{T}Λₛαₛ and αₛΛₛαₛ^{T}, where Λₛ is an eigenvalue matrix of the operator used to constrict the eigenbasis of the respective surface. For example, when the eigenbasis is a Laplacian eigenbasis, Λₛ is the eigenvalue matrix of the Laplacian operator.

Herein, expressions of the form CRC^{T} and C^{T}RC where, C and R are some matrices, are referred to as “the transformation of the matrix R using the matrix C”.

Thus, the optimization procedure is applied to traces of matrices obtained by transformations of the matrix Λₛ by the matrix αₛ. The optimization procedure is preferably subjected to the constraint (ΦₛαₛΦₛ^{T})ᵢⱼ=Dₛ(Vᵢ,Vⱼ), where Dₛ(Vᵢ,Vⱼ) is the distance between points Vᵢ and Vⱼ in the respective surface. This optimization can be written as:

$${min}_{{α}_{s} ∈ {ℝ}^{{m}_{e} \times {m}_{e}}} trace ( {α}_{s}^{T} {Λ}_{s} {α}_{s} ) + trace ( {α}_{s} {Λ}_{s} {α}_{s}^{T} ) + μ {\sum }_{( i , j ) ∈ {I}_{s}} {‖ {( {Φ}_{s} {α}_{s} {Φ}_{s}^{T} )}_{ij} - {D}_{s} ( {V}_{i} , {V}_{j} ) ‖}_{F}^{2} , \qquad EQ . 2$$

where Iₛ is the set of all pairs among the points over which the eigenbasis of the respective surface is calculated, and the notation ∥−∥_{F} represent the Frobenius norm. A typical value for μ is from about 0.1 to about 0.9. In experiments performed by the present inventor μ was selected to be 0.5. Any algorithm can be used to solve EQ. 2 for the matrix αₛ. A representative example is the PBM toolbox [Aharon Ben-Tal and Michael Zibulevsky, Penaltybarrier multiplier methods for convex programming problems, SIAM Journal on Optimization, 7(2):347-366, 1997].

Once the spectral representations are calculated, the method preferably continues to 16 at which a mapping matrix α is calculated based on the spectral representations. Unlike the spectral representation matrices αₛ, which are obtained separately for each surface, the mapping matrix α is calculated based on the representations of two, and optionally more than two, surfaces. The present inventors found that such a mapping matrix can be used to determine the correspondence between the two surfaces as further detailed hereinbelow. The dimension of the mapping matrix α is preferably M₁×M₂.

In some embodiments of the present invention the calculation of the mapping matrix α comprises an optimization procedure applied to a trace or a norm of a matrix Θ constructed from mapping matrix α and from the spectral representation matrices αₛ. the matrix Θ is composed of an ordered product of the matrices α and αₛ, were the mapping matrix α or its transpose α^{T} multiplies each of the spectral representation matrices αₛ.

The optimization procedure can be formulated in more than one way. In some embodiments of the present invention the matrix Θ is composed of an ordered product of all the matrices, were the mapping matrix α or its transpose α^{T} is interposed between pairs of the spectral representation matrices αₛ. Representative examples for the matrix Θ in these embodiments and for the case of two surfaces, include, without limitation, Θ=α^{T}α₂αα₁, Θ=αα₁α^{T}α₂, Θ=α^{T}α₁αα₂, and Θ=αα₂α^{T}α₁. The optimization procedure in these embodiments can be written as:

$${max}_{{α}_{s . t .}} trace ( Θ ) \\ {α}^{T} α = I , \\ ‖ {Λ}_{1} - {α}^{T} {Λ}_{2} α ‖ < ε , \\ α {C}_{1} = {C}_{2} , \\ {α}^{T} {C}_{2} = {C}_{1} . \qquad EQ . 3$$

The parameter c in EQ. 3 serves as a stopping parameter for the optimization. A typical value for c is about 0.05 or about 0.04 or about 0.03 or about 0.02 or about 0.01. In some embodiments, the multiplication between the mapping matrix α or its transpose α^{T} and the respective spectral representation matrices αₛ, is performed separately for each matrix, and the matrix Θ is composed of a linear combination of these multiplications. Representative examples for the matrix Θ in these embodiments and for the case of two surfaces, include, without limitation, Θ=αα₁−α^{T}α₂ and Θ=αα₂−α^{T}α₁. The optimization procedure in these embodiments can be written as:

$${min}_{{α}_{s . t .}} {‖ Θ ‖}_{2}^{2} + {μ}_{1} {‖ {Λ}_{1} - {α}^{T} {Λ}_{2} α ‖}_{2}^{2} + {μ}_{2} {‖ {α}^{T} α - I ‖}_{2}^{2} \\ α {C}_{1} = {C}_{2} , \\ {α}^{T} {C}_{2} = {C}_{1} . \qquad EQ . 4$$

Typical values for μ₁ and μ₂ are from about 0.1 to about 0.9. In experiments performed by the present inventor μ₁ and μ₂ were selected to be 0.5.

In the above optimization procedure, C₁ and C₂ are constants that can be calculated using the respective eigenbasis. In some embodiments of the present invention Cs=Φₛ^{T}Aₛ1, where s=1 or 2, Aₛ is the discretization matrix of the square root of determinant of the metric tensor of the respective surface, and [symbol] is a column vectors whose elements are all 1, namely [symbol] ^{T}=(1, 1, . . . , 1).

The optimization procedure (e.g., EQ. 3 or EQ. 4) is executed to obtain a solution for the mapping matrix α. Any algorithm can be used to solve EQ. 3 or EQ. 4 for the matrix α. A representative example is the aforementioned PBM toolbox.

The matrices αₛ and α are preferably calculated by the data processor. The total calculation time of these matrices is approximately the same for any value of M₁ and M₂. The overall calculation time for all the matrices αₛ and α is typically less than 10 or less than 5 seconds. Other calculation times (typically shorter) are also contemplated.

The method can then proceed to 17 at which the correspondence between the non-planar surfaces is determined, and to 18 at which the calculated correspondence is displayed and/or stored on a non-volatile computer readable medium. It was found by the present inventors that the mapping matrix α can be used for mapping between the bases of the surfaces and that this mapping can be used for calculating the correspondence between the surfaces. The advantage of these embodiments is that by mapping between the bases of the surfaces the size of the problem is significantly reduced. Thus, instead of searching for a point-wise matching between the points of the surfaces, the present embodiments determine a mapping between the bases of the surfaces. Since the size of the bases is significantly lower, the efficiency and accuracy of the method is significantly higher.

The correspondence can optionally and preferably be expressed as a matrix P, as further detailed hereinabove. When the correspondence is a matrix, each or a selection of the matrix-elements of P can be displayed or stored. One or more parameters that characterize the matrix (e.g., trace, determinant, eigenvectors, eigenvalues, etc.) can additionally or alternatively be displayed and/or stored. In a preferred embodiment, the matrix P is displayed graphically. For example, the coordinates of one or more of the surfaces can be used to produce a graphical representation (e.g., a computer generated image) of the surface, wherein some or all of the points of the graphical representation can be marked (e.g., using a color-coded marking) in accordance with the respective values of the matrix-elements of P that are associated with those points. Representative examples of such a graphical representation are provided in the Examples section that follows.

In some embodiments of the present invention the matrix P is calculated using the relation P=Φ₂αΦ₁^{T}A₁. This matrix represents the mapping of the basis Φ₁ onto the basis Φ₂. The inverse mapping (namely the mapping of the basis Φ₂ onto the basis Φ₁), can be obtained using the matrix P=Φ₁αΦ₂^{T}A₂.

The method ends at 19.

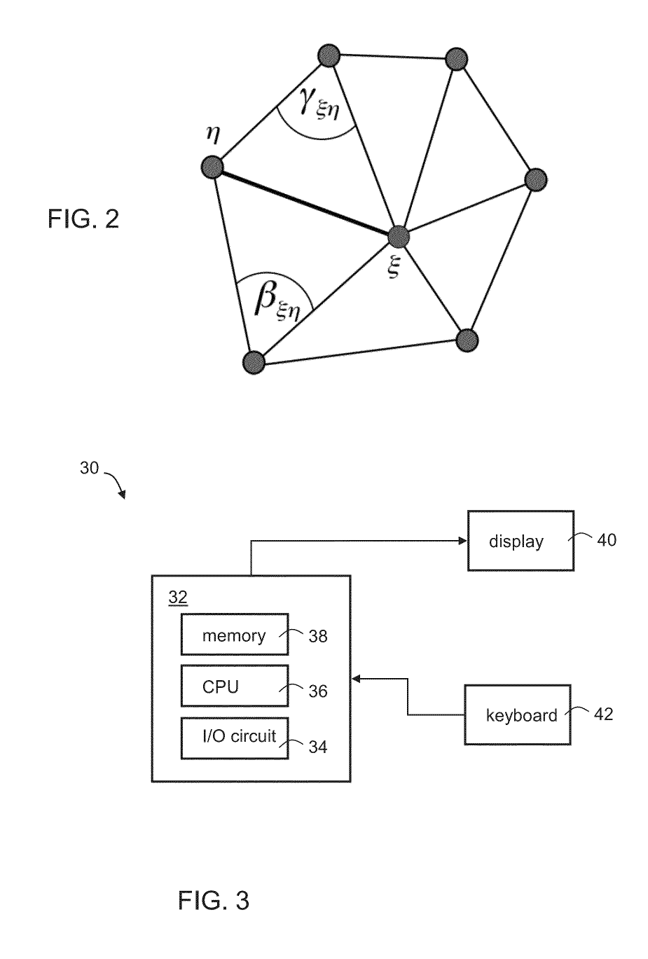

FIG. 3 is a schematic illustration of a data processing system 30 according to some embodiments of the present invention. System 30 comprises a computer 32, which typically comprises an input/output (I/O) circuit 34, a data processor, such as a central processing unit (CPU) 36 (e.g., a microprocessor), and a memory 46 which typically includes both volatile memory and non-volatile memory. I/O circuit 34 is used to communicate information in appropriately structured form to and from other CPU 36 and other devices or networks external to system 30. CPU 36 is in communication with I/O circuit 34 and memory 38. These elements can be those typically found in most general purpose computers and are known per se.

A display device 40 is shown in communication with data processor 32, typically via I/O circuit 34. Data processor 32 issued to display device 40 graphical and/or textual output images generated by CPU 36. A keyboard 42 is also shown in communication with data processor 32, typically I/O circuit 34.

It will be appreciated by one of ordinary skill in the art that system 30 can be part of a larger system. For example, system 30 can also be in communication with a network, such as connected to a local area network (LAN), the Internet or a cloud computing resource of a cloud computing facility.

In some embodiments of the invention data processor 32 of system 30 is configured for receiving coordinates of the surfaces, for calculating, for each surface, a spectral representation based on an eigenbasis of at least a portion of the surface; for calculating a mapping matrix, based on the spectral representations; for determining the correspondence between the non-planar surfaces, based on the mapping matrix and the eigenbases, and for displaying the correspondence and/or recording the correspondence on a non-volatile computer readable medium as further detailed hereinabove.

In some embodiments of the invention system 30 communicates with a cloud computing resource (not shown) of a cloud computing facility, wherein the cloud computing resource is configured for receiving coordinates of the surfaces, for calculating, for each surface, a spectral representation based on an eigenbasis of at least a portion of the surface; for calculating a mapping matrix, based on the spectral representations; for determining the correspondence between the non-planar surfaces, based on the mapping matrix and the eigenbases, and for displaying the correspondence and/or recording the correspondence on a non-volatile computer readable medium, as further detailed hereinabove.

The method as described above can be implemented in computer software executed by system 30. For example, the software can be stored in of loaded to memory 38 and executed on CPU 36. Thus, some embodiments of the present invention comprise a computer software product which comprises a computer-readable medium, more preferably a non-transitory computer-readable medium, in which program instructions are stored. The instructions, when read by data processor 32, cause data processor 32 to access the dataset and execute the method as described above.

Alternatively, the computation capabilities of system 30 can be provided by dedicated circuitry. For example, CPU 30 and/or memory 46 can be integrated into dedicated circuitry configured for receiving coordinates of the surfaces, for calculating, for each surface, a spectral representation based on an eigenbasis of at least a portion of the surface; for calculating a mapping matrix, based on the spectral representations; for determining the correspondence between the non-planar surfaces, based on the mapping matrix and the eigenbases, and for displaying the correspondence and/or recording the correspondence on a non-volatile computer readable medium.

As used herein the term “about” refers to ±10%.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

The present Inventors found a functional map representation that can cast the L₂ version of the Gromov-Hausdorff framework for matching deformable shapes into the spectral domain. The present Inventors successfully overcame the compromise of having to match multiple semi-local or differential structures also known as sparse matching, while reducing the overall complexity of the dense matching problem.

The present Inventors observed that the point-to-point correspondence itself between two shapes can be thought of as a functional map between the functional spaces of the shapes, and that distances measured on a shapes are smooth functions, and as such are well suited for the inventive functional map representation.

The present Example shows that the procedure of the present embodiments outperforms known dense correspondence solvers in terms of complexity and accuracy while substantially reducing the amount of required supporting features.

The following notations are used in the present example.

A two dimensional parameterized Riemannian manifold M, is considered. The metric tensor of the manifold is denoted G. The following several scalar products [symbol] .,. [symbol] _{G} are defined.

For any tangent plane of M at any point xεM, denoted by Tₓ(M), given two vectors (u, v)εTₓ(M), the scalar product [symbol] u,v [symbol] _{G} is defined as:

[symbol]

u,v [symbol] _{G}=u^{T}Gᵥ.

For any pair of functions (ƒ, h) defined on M, the scalar product [symbol] ƒ,h [symbol] _{G} is defined as:

[symbol]

ƒ,h [symbol] _{G}=∫∫_{p(M)}ƒ(x)h(x)\sqrt{g}dx,

where p(M) represents the parameterization space of M, and g=det(G).

For any pair of vector fields U and V defined on T(M), the scalar product [symbol] U,V [symbol] _{G} is defined as:

[symbol]

U,V [symbol] _{G}=∫∫_{p(M)}U(x)^{T}GV(x)\sqrt{g}dx.

For each of the above scalar products, the respective norm is defined as ∥•∥_{G}=\sqrt{ [symbol].,. [symbol] _{G}}.

The metric tensor G also defines the following differential geometric operations for any function ƒ that is defined over p(M):

$${∇}_{G} f = {G}^{- 1} {∇}_{x} f = \sqrt{g} {\sum }_{j} {g}^{ij} {\partial }_{j} f ,$$

where g^{ij}=(G⁻¹)_{i,j} and ∂ᵢ is the derivative with respect to the xᵢ coordinate; and

$${Δ}_{G} f = \frac{1}{\sqrt{g}} {\sum }_{i} {\partial }_{i} ( {∇}_{G} f ) = \frac{1}{\sqrt{g}} {\sum }_{i} {\partial }_{i} ( \sqrt{g} {\sum }_{j} {g}^{ij} {\partial }_{j} f ) .$$

### Functional Maps

Given two shapes S₁ and S₂, a functional map between S₁ and S₂ maps any function ƒ₁:S₁→ [symbol] to its image ƒ₂:S₂→ [symbol] . This map could be represented by an operator [symbol] defined on the functional space {ƒ₁:S₁→ [symbol] } and obtaining its values in {ƒ₂:S₂→ [symbol] }, such that ƒ₂= [symbol] (ƒ₁). If the mapping is linear, [symbol] is a linear operator and can be defined through a kernel k: S₁×S₂→ [symbol] , where

ƒ₂(y)= [symbol] [ƒ₁](y)=∫_{S}_{₁}k(x,y)ƒ₁(x)da₁(x), EQ. A.1

where xεS₁, yεS₂, da₁(x)=\sqrt{g₁} dy, and g₁=det(G₁) represents an infinitesimal area element of S₁.

For every kernel [symbol] , its conjugate [symbol] * is defined as:

[symbol]

[ƒ₂](x)=∫_{S}_{₂}k(x,y)ƒ₂(y)da₂(y). EQ. A.2

For simplicity, consider S₁ and S₂ to be two triangulated surfaces, in which case, a discrete version of EQ. A.1 can be defined by a matrix K, such that

η₂=KA₁ƒ₁ EQ. A.3

where A₁ is a diagonal matrix in which (A₁)ᵢᵢ is the area of the Voronoi cells about vertex i as introduced in [U. Pinkall and K Polthier, Computing discrete minimal surfaces and their conjugates, Experimental mathematics, 2(1):15-36, 1993], and K_{i,j}=k(xᵢyⱼ).

A functional map, linearly relating two functional spaces, represents an arbitrary relation between the two spaces. The following properties are preferably applied to the functional map:
Linearity, [symbol] (ƒ+λh)= [symbol] (ƒ)+λ [symbol] (h)
Smoothness, [symbol] maps a smooth function to a smooth function.
Unitarity ƒ= [symbol] *( [symbol] (ƒ)).
Mass preservation,

∫_{S}_{₂} [symbol] (ƒ₁)da₂=∫_{S}_{₁}ƒ₁da₁

and

∫_{S}_{₁} [symbol] *(ƒ₂)da₁=∫_{S}_{₂}ƒ₂da₂.
Local area preservation, or generalized Parseval's identity,

∀ΩεS₁,∫_{S}_{₁} [symbol] _{Ω}da₁=∫_{S}_{₁} [symbol] ( [symbol] _{Ω})da₂.

where [symbol] _{Ω} is an indicator function that is equal to one in Ω and zero elsewhere.
Conformality, if (u,v) is a conformal parametrization of S₁, then ( [symbol] (u), [symbol] (v)) is a conformal parametrization of S₂.

Local area preservation holds, if:

∫_{S}_{₁}hfda₁=∫_{S}_{₂} [symbol] (h) [symbol] (ƒ)da₂,∀ƒ,hε{S₁→ [symbol] }.

Conformality holds, if, ∀ƒ,hε{S₁→ [symbol] }:

∫_{S}_{₁} [symbol] ∇_{G}_{₁}h,∇_{G}_{₁}ƒ [symbol] _{G}_{₁}da₁=∫_{S}_{₂} [symbol] ∇_{G}_{₂} [symbol] (h),∇_{G}_{₂} [symbol] (ƒ) [symbol] _{G}_{₂}da₂.

where ∇_{Gi} is the gradient with respect to the metric Gᵢ of Sᵢ, i=1, 2.

The smoothness of a map reflects its ability to map a smooth function to a smooth function.

One way to quantify the smoothness of such a map is to measure its Dirichlet energy. The Dirichlet energy of the map [symbol] between two function spaces one on S₁ and the other on S₂, can be defined by

E_{Dirichlet}( [symbol] )=∫∫_{S}_{₁}_{,S}_{₂}∥∇_{G}_{₁}₍ₓ₎k(x,y)∥²da₁(x)da₂(y)+∫∫_{S}_{₁}_{,S}_{₂}∥∇_{G}_{₂}_{(y)}k(x,y)∥²da₁(x)da₂(y),

For any map k(x,y), integration by parts yields

∫_{S}_{₁}∥∇_{G}_{₁}₍ₓ₎k(x,y)∥²da₁(x)da₁(x)=∫_{S}_{₁}(Δ_{G}_{₁}₍ₓ₎k(x,y),k(x,y))da₁(x),

where Δ_{Gi} represent the Laplace Beltrami operator of Sᵢ.

Using these relations one obtains:

$$\int {\int }_{{S}_{2} , {S}_{1}} {‖ {∇}_{{G}_{2} ( y )} k ( x , y ) ‖}^{2} d {a}_{2} ( y ) d {a}_{1} ( x ) = \int {\int }_{{S}_{2} , {S}_{1}} 〈 {Δ}_{{G}_{2 ( y )}} k ( x , y ) , k ( x , y ) 〉 d {a}_{2} ( y ) d {a}_{1} ( x ) \approx {\sum }_{i} {( {A}_{1} )}_{ii} {K}_{i}^{T} {W}_{2} {K}_{i} = {\sum }_{i} {( {A}_{1} )}_{ii} trace ( {W}_{2} {K}_{i} {K}_{i}^{T} ) = trace ( {W}_{2} \underbrace{( {\sum }_{j} {K}_{j} {{K}_{j}^{T} ( {A}_{1} )}_{jj} )}_{{KA}_{1} {K}^{T}} ) = trace ( {W}_{2} {KA}_{1} {K}^{T} ) ,$$

where Wᵢ represents the cotangent weight matrix of the discretized Laplace Beltrami operator, Δ_{Gi}≈Aᵢ⁻¹Wᵢ.

It can be similarly shows that

∫∫_{S}_{₁}_{,S}_{₂}∥∇_{G}_{₁}₍ₓ₎k(x,y)∥²da₁(x)da₂(y)≈trace(W₁K^{T}A₁K).

The discrete Dirichlet energy of a functional map can now be approximated by

E_{Dirichlet}(K)=trace(W₂KA₁K^{T})+trace(W₁K^{T}A₂K). EQ. A.4

Mass preservation can be defined by the following relations

∫_{S}_{₂} [symbol] (ƒ₁)da₂=∫_{S}_{₁}ƒ₁da₁,

and

∫_{S}_{₁} [symbol] (ƒ₂)da₁=∫_{S}_{₂}ƒ₂da₂.

Translating these conditions to matrix notations, the mass preservation property can be discretized into,

KA₁ [symbol] =

[symbol]

K^{T}A₂ [symbol] = [symbol] . EQ. A.5

where [symbol] is vector whose components are all equal to one.

As an example of a functional unitarity, the Fourier transform is considered.

Let [symbol] be a Fourier transform, then,

ƒ= [symbol] *( [symbol] (ƒ)).

Associating this property to the kernel in EQ. A.1 allows writing

$$\begin{matrix}{f}_{1} ( x ) = {\int }_{{S}_{2}} k ( z , x ) \underbrace{( {\int }_{{S}_{1}} k ( z , \tilde{x} ) {f}_{1} ( \tilde{x} ) d {a}_{1} ( \tilde{x} ) )}_{{f}_{2} ( z )} d {a}_{2} ( z ) \\ = \int {\int }_{{S}_{1} , {S}_{2}} k ( z , x ) k ( z , \tilde{x} ) {f}_{1} ( \tilde{x} ) d {a}_{1} ( \tilde{x} ) d {a}_{2} ( z ) ,\end{matrix}$$

and in a discrete setting,

K^{T}A₂KA₁=I EQ. A.6

where I is the identity matrix.

This relation is equivalent to A₂KA₁K^{T}=I, in which case, for any unitary map, to one has,

KA₁K^{T}=A₂⁻¹

K^{T}A₂K=A₁⁻¹

Substituting the above formulas into EQ. A.4, it turns out that the Dirichlet energy of any unitary map is constant. Moreover, if the map [symbol] is unitary, then, for all functions ƒ,hε{S₁→ [symbol] } one has,

∫_{S}_{₂} [symbol] (h) [symbol] (ƒ)da₂=∫_{S}_{₁}h [symbol] *( [symbol] (ƒ))da₁=∫_{S}_{₁}hƒda₁.

This demonstrates the equivalence between a unitary map and a local area preserving map.

The conformality, also known as angular, or isotropy preserving, of a functional map [symbol] is equivalent to,

∫_{S}_{₁} [symbol] ∇_{G}_{₁}h,∇_{G}_{₁}ƒ [symbol] _{G}_{₁}da₁=∫_{S}_{₂} [symbol] ∇_{G}_{₂} [symbol] (h),∇_{G}_{₂} [symbol] (ƒ) [symbol] _{G}_{₂}da₂,∀ƒ,hε{S₁→ [symbol] }.

Invoking Stockes theorem, the above equation can be written as

$$\begin{matrix}{\int }_{{S}_{1}} h {Δ}_{{G}_{1}} f d {a}_{1} = {\int }_{{S}_{2}} K ( h ) {Δ}_{{G}_{2}} K ( f ) d {a}_{2} \\ = {\int }_{{S}_{1}} {hK}^{*} ( {Δ}_{{G}_{2}} K ( f ) ) d {a}_{1} , ∀ f , h ∈ \{ {S}_{1} -> ℝ \} ,\end{matrix}$$

that is equivalent to

ΔG₁·= [symbol] *(Δ_{G}_{₂} [symbol] (•)),

or in discrete setting

A₁⁻¹W₁=K^{T}A₂(A₂⁻¹W₂)KA₁=K^{T}W₂KA₁. EQ. A.7

### Eigenspace Formulation

Let Φᵢ be the matrix that represents the eigenfunctions of the Laplace Beltrami operator of Sᵢ and Λᵢ its associated eigenvalues diagonal matrix, such that WᵢΦᵢ=AᵢΦᵢΛᵢ. The spectral representation of K with respect to Φ₁ and Φ₂ can be described by a matrix α such that

K=Φ₂αΦ₁^{T}

In this setting, one has,

K^{T}A₂K A₁=Φ₁α^{T}Φ₂^{T}A₂Φ₂αΦ₁^{T}A₁=Φ₁α^{T}αΦ₁^{T}A₁

since

Φ₁^{T}A₂Φ₂=I

Now, EQ. A.6 can be written as

Φ₁α^{T}αΦ₁^{T}A₁=I

Multiplying the left hand side by Φ₁^{T}A₁ and the right hand side by Φ₁, one has

Φ₁^{T}A₁Φ₁=I

so that EQ. A.6 is simplified to

α^{T}α=I

Along the same line, the discrete Dirichlet energy EQ. A.4 can be similarly simplified into

$$\begin{matrix}{E}_{Dirichlet} ( K ) = trace ( {W}_{2} {KA}_{1} {K}^{T} ) + trace ( {W}_{1} {K}^{T} {A}_{2} K ) \\ = trace ( {W}_{2} {Φ}_{2 } \underbrace{{αΦ}_{1}^{T} {A}_{1} {Φ}_{1}}_{I} {α}^{T} {Φ}_{2}^{T} ) + \\ trace ( {W}_{1} {Φ}_{1} {α}^{T} \underbrace{{Φ}_{2}^{T} {A}_{2} {Φ}_{2}}_{I} {αΦ}_{1}^{T} ) \\ = trace ( {W}_{2} {Φ}_{2} α {α}^{T} {Φ}_{2}^{T} ) + trace ( {W}_{1} {Φ}_{1} {α}^{T} α {Φ}_{1}^{T} ) \\ = trace ( {αα}^{T} \underbrace{{Φ}_{2}^{T} {W}_{2} {Φ}_{2}}_{{Λ}_{2}} ) + trace ( {α}^{T} α \underbrace{{Φ}_{1}^{T} {W}_{1} {Φ}_{1}}_{{Λ}_{1}} ) \\ = trace ( α {α}^{T} {Λ}_{2} ) + trace ( {α}^{T} α {Λ}_{1} ) .\end{matrix}$$

The conformality equation EQ. A.7 reads

A₁⁻¹W₁=K^{T}W₂KA₁,

and can be rewritten as

$${W}_{1} = {A}_{1} {Φ}_{1} {α}^{T} \underbrace{{Φ}_{2}^{T} {W}_{2} {Φ}_{2}}_{{Λ}_{2}} α {Φ}_{1}^{T} {A}_{1} ,$$

that is equivalent to

$$\underbrace{{Φ}_{1}^{T} {W}_{1} {Φ}_{1}}_{{Λ}_{1}} = \underbrace{{Φ}_{1}^{T} {A}_{1} {Φ}_{1}}_{I} {α}^{T} {Λ}_{2} α \underbrace{ {Φ}_{1}^{T} {A}_{1} {Φ}_{1}}_{I} , \\ or$$

$${Λ}_{1} = {α}^{T} {Λ}_{2} α .$$

The mass preservation, EQ. A.5, can be rewritten as

Φ₁αΦ₁^{T}A₁ [symbol] =

[symbol]

Φ₁α^{T}Φ₂^{T}A₂ [symbol] = [symbol] ,

that is equivalent to

αC₁=C₂

α^{T}C₂=C₁, EQ. A.8

where

Cᵢ=Φᵢ^{T}Aᵢ [symbol] ,i=1,2.

In the present Example, a spectral representation of smooth low area and angle distortion, mass preserving, linear maps, having the following properties is considered:

K=Φ₂αΦ₁^{T},

∥α^{T}α−I∥, is sufficiently small,

∥Λ₁−α^{T}Λ₂α∥ is sufficiently small,

trace(αα^{T}Λ₂)+trace(α^{T}αΛ₁) is sufficiently small,

α C₁=C₂, and

α^{T} C₂=C₁.

### Spectral Interpolation

A triangulated surface S, with n vertices Vᵢ, and [symbol] a subset of 1, 2, . . . , n such that ∥ [symbol] =m≦n, is considered.

Given a map D: S×S→ [symbol] defined to every pair of points of S, and whose values are known at a given set of M points [symbol] ={Vⱼ,jε [symbol] }, the value of D can be extended by interpolating the value of D over the other points of S, such that the obtained map is sufficiently smooth. Formally, one can find a map h defined on S×S whose values obtains at [symbol] × [symbol] coincides with the values of D, and whose Dirichlet Energy introduced above is minimal. This problem of smooth interpolation could be written as

$${min}_{h : S -> R} {E}_{Dirichlet} ( h )$$

$$s . t . h ( {V}_{i} , {V}_{j} ) = D ( {V}_{i} , {V}_{j} ) ∀ ( i , j ) ∈ ( 𝒥 \times 𝒥 ) .$$

Using the spectral reformulation of this energy and defining by α the spectral representation of h, the problem can be rewritten as

min trace(α^{T}Λα)+trace(αΛα^{T})

s.t.(ΦαΦ^{T})ᵢⱼ=D(Vᵢ,Vⱼ),∀(i,j)ε [symbol] , EQ. A.9

where (Λ, Φ) represent the diagonal matrices of eigenvalues and the matrix of eigenfunctions of the Laplace-Beltrami operator of S.

Expressing the constraint as a penalty function, the following optimization problem is obtained

$${min}_{α ∈ {ℝ}^{{m}_{e} \times {m}_{e}}} trace ( {α}^{T} Λ α ) + trace ( {αΛα}^{T} ) + μ {\sum }_{( i , j ) ∈ I} {‖ {( {ΦαΦ}^{T} )}_{ij} - D ( {V}_{i} , {V}_{j} ) ‖}_{F}^{2} , \qquad EQ . A .10$$

This problem is a minimization problem of a quadratic function of a. Then, representing a as an row-stack vector a, the problem can be rewritten as a quadratic programming problem.

### Generalized Multidimensional Scaling

The Generalized Multi-Dimensional Scaling (GMDS) is a procedure that computes the map that best preserves the inter-geodesic distances while embedding one surface into another.

Formally, if Φ₁ and Φ₂ represent the inter-geodesic distances matrix of S₁ and S₂, respectively, roughly speaking, the GMDS attempts to find the permutation matrix P minimizing ∥PD₁−D₂P∥₂². This can be written as

$${min}_{{P}_{s . t .}} {‖ {PD}_{1} - {P}_{2} P ‖}_{2}^{2} \\ P 1 = 1 , \\ {P}^{T} 1 = 1 , \\ {P}_{ij} ∈ \{ 0 , 1 \} , ∀ ( i , j ) . \qquad EQ . A .11$$

The present Example soften the hard constraint Pᵢⱼₗε{0,1}, ∀(i,j), and consider a solution which is a unitary, mass and inter-geodesic distances preserving solution, with minimal conformal distortion, that produces a bijective linear map from S₁ to S₂, and defines a fuzzy correspondence between the surfaces.

PX is replaced with PA₁X and XP is replaced with XA₂P.

The new problem is defined by

$${min}_{{P}_{s . t .}} {‖ {PA}_{1} {D}_{1} - {D}_{2} {A}_{2} P ‖}_{2}^{2} \\ {PA}_{1} 1 = 1 , \\ {P}^{T} {A}_{2} 1 = 1 , \\ {P}^{T} {A}_{2} {PA}_{1} = I , \\ ‖ {W}_{1} - {A}_{1} {P}^{T} {W}_{2} {PA}_{1} ‖ < ε , \qquad EQ . A .12$$

where ∥•∥₂² represents the discretization of the L₂ norm of a mapping between S₁ and S₂.

In continuous setting,

∥F∥₂²=∫∫_{S}_{₁}_{,S}_{₂}F²(x,y)da(x₁)da(x₂),

and in its discrete version,

∥F∥₂²≈trace(F^{T}A₂FA₁).

The L₂ measure defined in EQ. A.12 thus reads,

$${‖ {PA}_{1} {D}_{1} - {D}_{2} {A}_{2} P ‖}_{2}^{2} = trace ( {( {PA}_{1} {D}_{1} - {D}_{2} {A}_{2} P )}^{T} {A}_{2} ( {PA}_{1} {D}_{1} - {D}_{2} {A}_{2} P ) {A}_{1} ) = - 2 trace ( {P}^{T} {A}_{2} {D}_{2} {A}_{2} {PA}_{1} {D}_{1} {A}_{1} ) + C ,$$

exploiting the relation P^{T}A₂PA₁=I.

EQ. A.12 can then be reformulated as

$${max}_{{P}_{s . t .}} trace ( {P}^{T} {A}_{2} {D}_{2} {A}_{2} {PA}_{1} {D}_{1} {A}_{1} ) \\ {PA}_{1} 1 = 1 , \\ {P}^{T} {A}_{2} 1 = 1 , \\ {P}^{T} {A}_{2} {PA}_{1} = I , \\ ‖ {W}_{1} - {A}_{1} {P}^{T} {W}_{2} {PA}_{1} ‖ < ε . \qquad EQ . A .13$$

### Correspondence Between Surfaces

The present Inventors found that the correspondence P can be viewed as a functional map between S₁ and S₂, up to area normalization.

Thus, following the above analysis one writes

P=Φ₂αΦ₁^{T}A₁. EQ. A.14

The inverse operator is defined as

P^{T}=Φ₁α^{T}Φ₂^{T}A₂, EQ. A.15

so that the P^{T} A₂ P A₁=I, holds for the correspondence map P.

As shown above, this condition is equivalent to α^{T} α=I. In addition, for P to be mass preserving, similar constraints are obtained on the mapping α

αΦ₁^{T}A₁ [symbol] =Φ₂^{T}A₂ [symbol] , EQ. A.16

α^{T}Φ₂^{T}A₂ [symbol] =Φ₁^{T}A₁ [symbol] . EQ. A.17

One of the consequences of using the functional map representation of the correspondence is a reduction of the size of the problem. A search for a point-wise matching between the vertices of S₁ and those of S₂, with Pε[0, 1]^{[|S1|×|S2|}}, was reduced to the map α relating between the bases Φ₁ and Φ₂, that is of size M₁×M₂, where M₁×M₂<<|S₁|×|S₂|.

Interpolated distance matrices \tilde{D}ᵢ, i=1, 2 can be defined as follows:

\tilde{D}ᵢ=ΦᵢαᵢΦᵢ^{T},i=1,2. EQ. A.18

The target measure EQ. A.13, now reads

$${max}_{P} trace ( {P}^{T} {A}_{2} {D}_{2} {A}_{2} {PA}_{1} {D}_{1} {A}_{1} ) = {max}_{α} trace ( {α}^{T} {α}_{2} {αα}_{1} \underbrace{{Φ}_{1}^{T} {A}_{1} {Φ}_{1}}_{= I} ) = {max}_{α} trace ( {α}^{T} {α}_{2} {αα}_{1} ) .$$

This leads to the following optimization problem, in which α is the new argument.

$${max}_{{α}_{s . t .}} trace ( {α}^{T} {α}_{2} {αα}_{1} ) \\ {α}^{T} α = I , \\ ‖ {Λ}_{1} - {α}^{T} {Λ}_{2} α ‖ < ε , \\ α {C}_{1} = {C}_{2} , \\ {α}^{T} {C}_{2} = {C}_{1} . \\ where {C}_{1} = {Φ}_{1}^{T} {A}_{1} , and {C}_{2} = {Φ}_{2}^{T} {A}_{2} . \qquad EQ . A .19$$

This optimization problem can be rewritten with some of the constraints as penalty measures:

$${min}_{{α}_{s . t .}} {‖ {αα}_{1} - {α}^{T} {α}_{2} ‖}_{2}^{2} + {μ}_{1} {‖ {Λ}_{1} - {α}^{T} {Λ}_{2} α ‖}_{2}^{2} + {μ}_{2} {‖ {α}^{T} α - I ‖}_{2}^{2} \\ α {C}_{1} = {C}_{2} , \\ {α}^{T} {C}_{2} = {C}_{1} . \qquad EQ . A .20$$

### Experimental

Several experiments were performed. Two publicly available datasets were used: TOSCA [Bronstein et al., Numerical geometry of non-rigid shapes, Springer, 2008], and SCAPE [Anguelov et al., The correlated correspondence algorithm for unsupervised registration of nonrigid surfaces, Advances in neural information processing systems, 17:33-40, 2004]. The TOSCA dataset contains 90 densely sampled synthetic human and animal surfaces, divided into several classes with given point-to-point correspondences between the shapes within each class. The SCAPE dataset contains scans of real human bodies in different poses.

In all the experiments, pre-computed geodesic distances between a subset of surface points, as defined in EQ. A.18 were used. The geodesic distances were calculated using the fast marching method [Kimmel and Sethian, supra], between 5% of surface points, sampled using the farthest point sampling method [Hochbaum et al., supra]. To minimize the objective function in EQ. A.20 the PBM toolbox was used [Ben-Tal and Zibulevsky, supra].

All the experiments were executed on a 2.7 GHz Intel Core i7 machine with 16 GB RAM. Average runtimes (in seconds) for pairs of shapes of various sizes from the TOSCA dataset are shown in Table 1, below.

TABLE 1

| No. of Vertices | 4344 | 19248 | 27894 | 45659 | 52565 |
|---|---|---|---|---|---|
| No. of Sampled vertices | 217 | 962 | 1394 | 2282 | 2628 |
| LB + eigs | 0.62 | 2.69 | 4.06 | 6.43 | 7.47 |
| Spectral GMDS | 4.74 | 4.53 | 4.85 | 4.43 | 4.23 |
| Total | 5.36 | 7.22 | 8.92 | 10.86 | 11.71 |

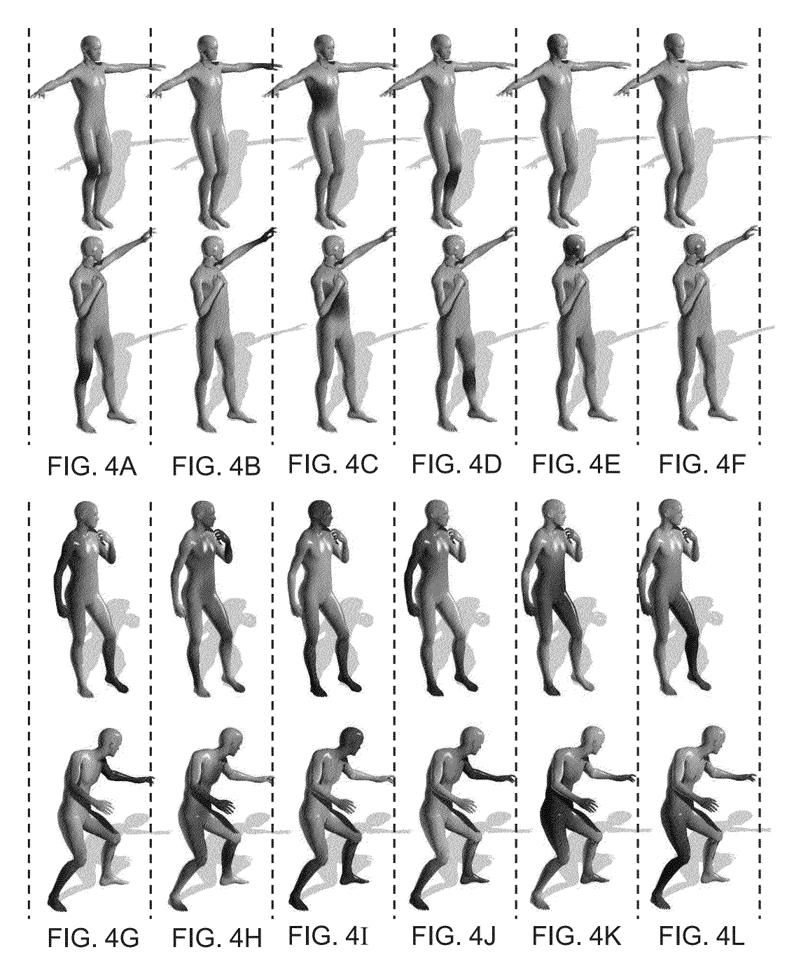

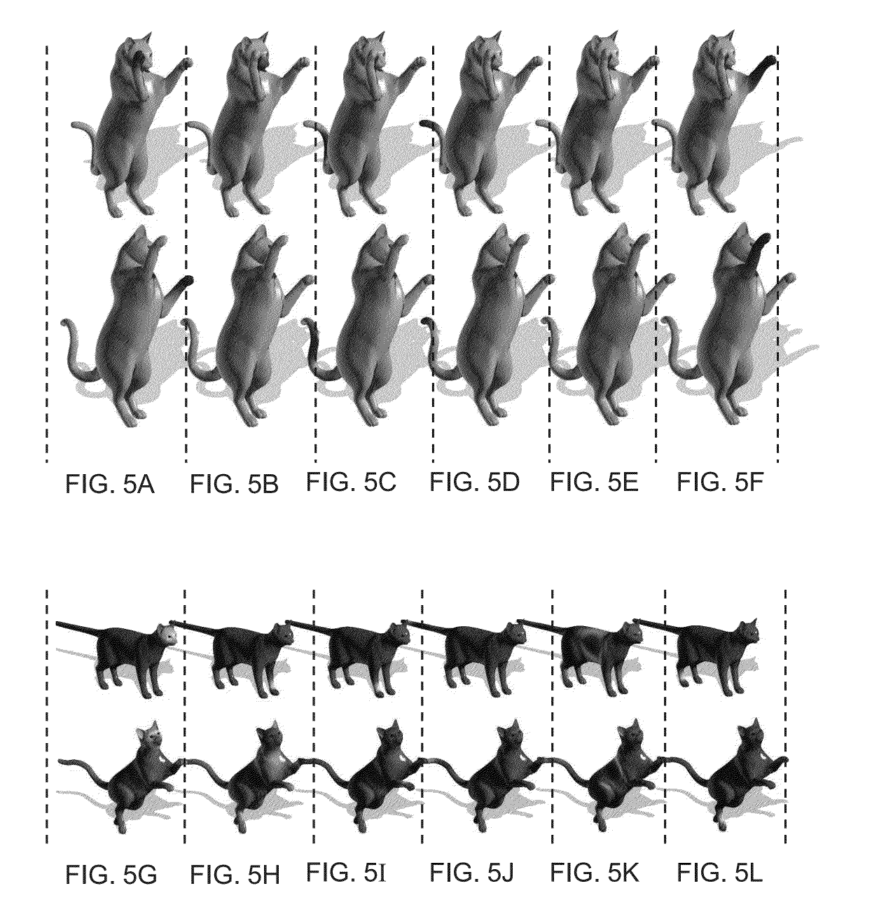

In a first experiment, almost isometric surfaces within the same were selected from the TOSCA dataset, and correspondences between them were computed using the technique of the present embodiments. The quality of the mapping was visualized by transferring a couple of functions defined on one shape to the other, using a procedure found in [Ovsjanikov et al., Functional maps: a flexible representation of maps between shapes, ACM Trans. Graph, 31(4):30:1-30:11, July 2012]. This is shown in FIGS. 4A-L and 5A-L, where in each Figure, the mapping between is the shape at the top and the shape at the bottom, and is shown using color codes.

FIG. 6 shows a visualization of point-to-point correspondences among several almost isometric poses of a horse, obtained using the technique of the present embodiments. The mapping is among all the shapes shown in FIG. 6, and is shown using color codes.

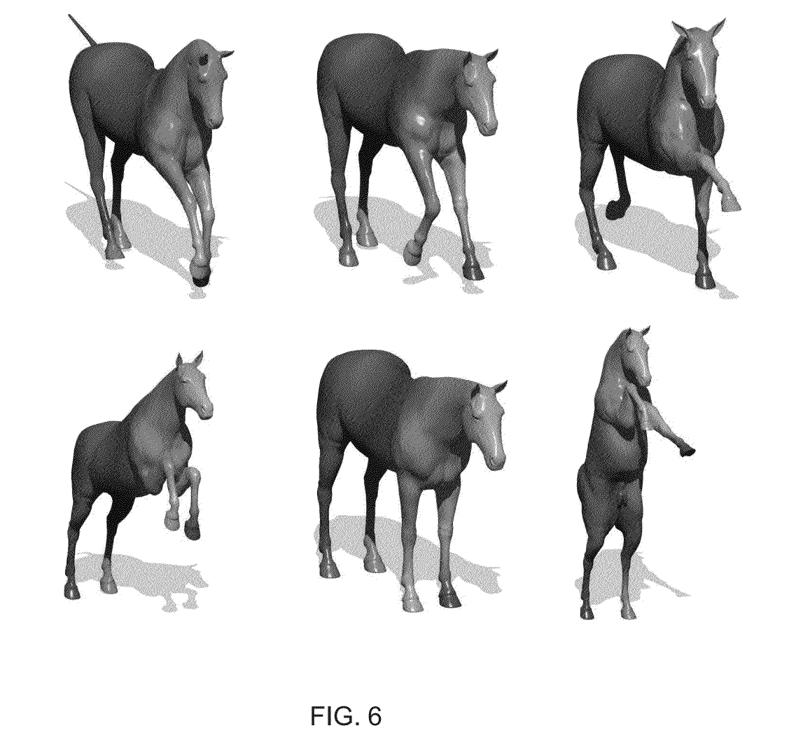

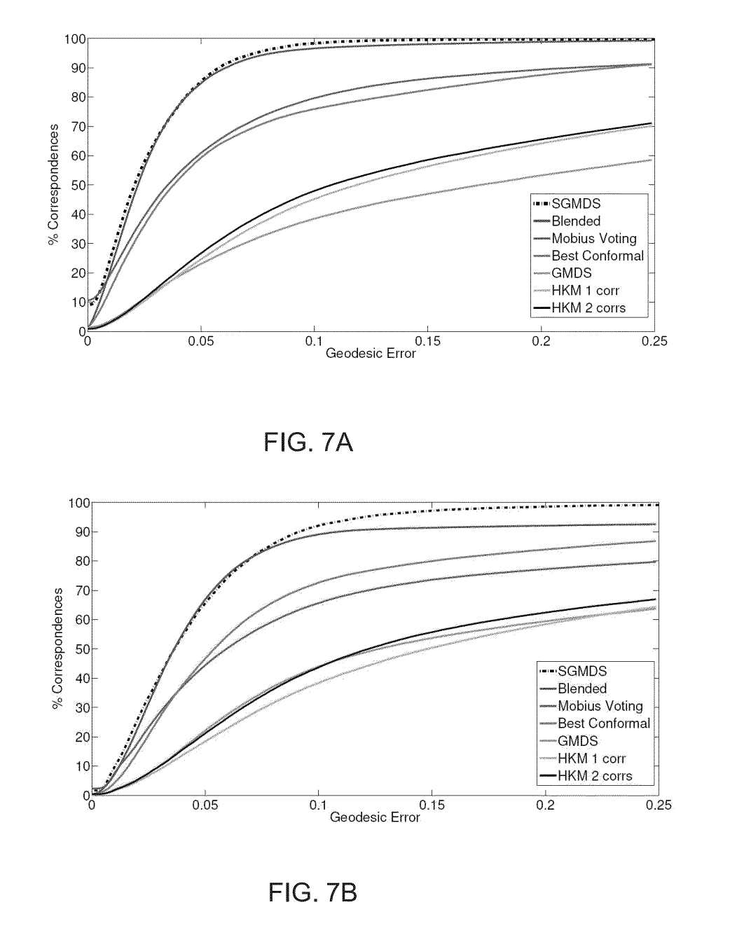

FIGS. 7A and 7B compare the accuracy of the technique of the present embodiments to other methods using the evaluation procedure found in Kim et al., Blended intrinsic maps, In ACM SIGGRAPH 2011 papers, pages 79:1-79:12, New York, N.Y., USA, 2011. The evaluation protocol was applied to both TOSCA and SCAPE datasets. For the other methods, the information provided in Kim et al. was used. The accuracy of the technique of the present embodiments is shown in a dotted line denoted SGMDS.

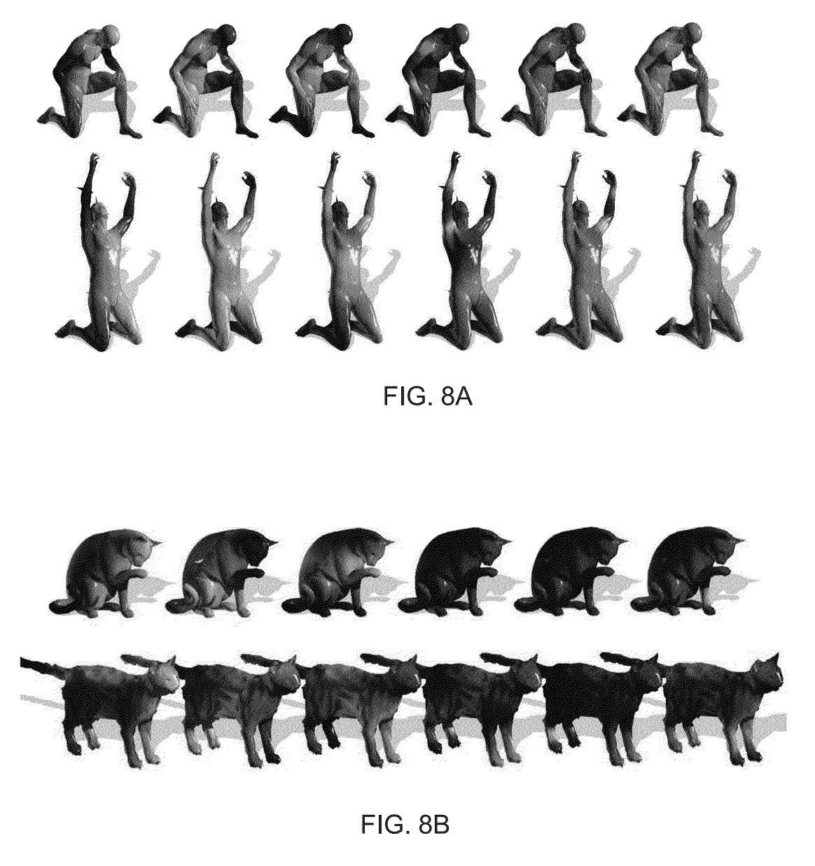

FIGS. 8A and 8B demonstrate the robustness of the technique of the present embodiments to typical types of noise.

In the benchmark protocol proposed by Kim et al. supra, the so-called ground-truth correspondence between shapes is assumed to be given. Then, a script, provided by the authors, computes the geodesic departure of each point, mapped by the evaluated method, from what the authors refer to as true location. The distortion curves describe the percentage of surface points falling within a relative geodesic distance from what is assumed to be their true locations. For each shape, the geodesic distance is normalized with respect to the shape's squared root of the area. It is noted that measuring the geodesic distortion of the given correspondences demonstrates a substantial discrepancy between corresponding pairs of points on most surface pairs from the given datasets. The distortion curves would thereby have an intrinsic ambiguity of about 5%-25%. The results obtained using conventional techniques thus reflect departure from the isometric model, or over-fitting to the dataset or smooth interpolation between corresponding features, rather than the departure of the evaluated method from the isometry criterion. The geodesic errors computed for the provided datasets could account for subjective model fidelity rather than its axiomatic objective isometric accuracy. Based on FIG. 6 in Ovsjanikov et al. supra, the results by Kim et al. supra can be reference for conventional techniques.

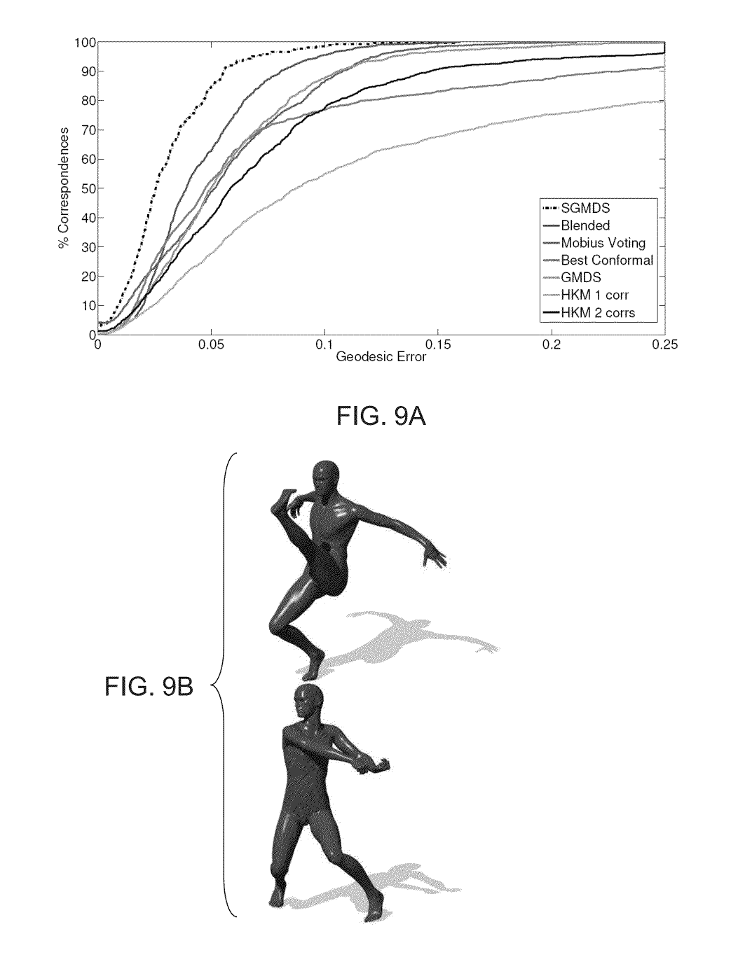

Still, even in this setting, the method of the present embodiments competes favorably with results obtained by conventional techniques. In a more favorable scenario, given two shapes for which the corresponding geodesic distortion is relatively small, the technique of the present embodiments provides superior results compared to existing methods, as demonstrated in FIGS. 9A and 9B.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

### REFERENCES

[1] Aharon Ben-Tal and Michael Zibulevsky. Penaltybarrier multiplier methods for convex programming problems. SIAM Journal on Optimization, 7(2):347-366, 1997.
[2] P. Berard, G. Besson, and S. Gallot. Embedding riemannian manifolds by their heat kernel. Geometric and Functional Analysis, 4(4):373-398, 1994.
[3] Paul J Best and Neil D McKay. Method for registration of 3-d shapes. In Robotics-DL tentative, pages 586-606. International Society for Optics and Photonics, 1992.
[4] Borg and P. Groenen. Modern Multidimensional Scaling: Theory and Applications. Springer, 1997.
[5] Alexander M Bronstein, Michael Bronstein, Michael M Bronstein, and Ron Kimmel Numerical geometry of non-rigid shapes. Springer, 2008.
[6] Alexander M. Bronstein, Michael M. Bronstein, and Ron Kimmel. Generalized multidimensional scaling: A framework for isometry-invariant partial surface matching. Proceedings of the National Academy of Sciences of the United States of America, 103(5):1168-1172, 2006.
[7] M. M. Bronstein, A. M. Bronstein, R. Kimmel, and I. Yavneh. Multigrid multidimensional scaling. Numerical Linear Algebra with Applications, 13(2-3):149-171, 2006.
[8] Yang Chen and Gerard Medioni. Object modeling by registration of multiple range images. In Robotics and Automation, 1991. Proceedings, 1991 IEEE International Conference on, pages 2724-2729. IEEE, 1991.
[9] Dubrovina and R. Kimmel Approximately isometric shape correspondence by matching pointwise spectral features and global geodesic structures. Advances in Adaptive Data Analysis, 3(1-2):203-228, 2011.
[10] Elad and R. Kimmel On bending invariant signatures for surfaces. IEEE Trans. Pattern Analysis and Machine Intelligence (PAMI), 25(10):1285-1295, 2003.
[11] Xianfeng Gu, Yalin Wang, Tony F Chan, Paul M Thompson, and Shing-Tung Yau. Genus zero surface conformal mapping and its application to brain surface mapping. Medical Imaging, IEEE Transactions on, 23(8):949-958, 2004.
[12] Dorit S Hochbaum and David B Shmoys. A best possible heuristic for the k-center problem. Mathematics of operations research, 10(2):180-184, 1985.
[13] Vladimir G. Kim, Yaron Lipman, and Thomas Funkhouser. Blended intrinsic maps. In ACM SIGGRAPH 2011 papers, SIGGRAPH '11, pages 79:1-79:12, New York, N.Y., USA, 2011. ACM.
[14] R. Kimmel and J. A. Sethian. Computing geodesic paths on manifolds. In Proc. Natl. Acad. Sci. USA, pages 8431-8435, 1998.
[15] Bruno Levy. Laplace-Beltrami eigenfunctions towards an algorithm that “understands” geometry. In Shape Modeling and Applications, 2006. SMI 2006. IEEE International Conference on, pages 13-13. IEEE, 2006.
[16] Diana Mateus, Radu Horaud, David Knossow, Fabio Cuzzolin, and Edmond Boyer. Articulated shape matching using laplacian eigenfunctions and unsupervised point registration. In Computer Vision and Pattern Recognition, 2008. CVPR 2008. IEEE Conference on, pages 1-8. IEEE, 2008.
[17] Facundo Memoli. On the use of Gromov-Hausdorff distances for shape comparison. In M. Botsch, R. Pajarola, B. Chen, and M. Zwicker, editors, Symposium on Point Based Graphics, pages 81-90, Prague, Czech Republic, 2007. Eurographics Association.
[18] Facundo Memoli and G. Sapiro. A theoretical and computational framework for isometry invariant recognition of point cloud data. Found. Comput. Math, 5(3):313-347, 2005.
[19] M. Ovsjanikov, M. Ben-Chen, J. Solomon, A. Butscher, and L. Guibas. Functional maps: a flexible representation of maps between shapes. ACM Trans. Graph., 31(4):30: 1-30:11, July 2012.
[20] U. Pinkall and K Polthier. Computing discrete minimal surfaces and their conjugates. Experimental mathematics, 2(1):15-36, 1993.
[21] Jonathan Pokrass, Alexander M. Bronstein, Michael M. Bronstein, Pablo Sprechmann, and Guillermo Sapiro. Sparse modeling of intrinsic correspondences. Computer Graphics Forum (EUROGRAPHICS), 32:459-268, 2013.
[22] Dan Raviv, Anastasia Dubrovina, and Ron Kimmel Hierarchical matching of non-rigid shapes. In Scale Space and Variational Methods in Computer Vision, pages 604-615. Springer, 2012.
[23] Guy Rosman, Alexander M Bronstein, Michael M Bronstein, Avram Sidi, and
Ron Kimmel. Fast multidimensional scaling using vector extrapolation. SIAM J. Sci. Comput., 2, 2008.
[24] J. Sun, M. Ovsjanikov, and L. Guibas. A concise and provably informative multi-scale signature based on heat diffusion. In Proceedings of the Symposium on Geometry Processing, SGP '09, pages 1383-1392, Aire-la-Ville, Switzerland, Switzerland, 2009. Eurographics Association.
[25] G. Zigelman, R. Kimmel, and N. Kiryati. Texture mapping using surface flattening via multidimensional scaling. Visualization and Computer Graphics, IEEE Transactions on, 8(2):198-207, 2002.

What is claimed is:

1. A method of determining correspondence between non-planar surfaces, the method comprising:
using a data processor for calculating, for each surface, a spectral representation based on an eigenbasis of at least a portion of said surface;
using said data processor for calculating a mapping matrix, based on said spectral representations;
using said data processor for determining the correspondence between the non-planar surfaces, based on said mapping matrix and said eigenbases, and for displaying said correspondence and/or storing said correspondence on a non-volatile computer readable medium.

2. The method of claim 1, wherein at least one of said non-planar surfaces is characterized by a dissimilarity matrix, and wherein said calculation of said spectral representation is also based on said dissimilarity matrix.

3. The method of claim 2, further comprising calculating said dissimilarity matrix.

4. The method of claim 3, wherein said calculating said dissimilarity matrix comprises calculating a dissimilarity measure between every two points of said at least a portion of said surface.

5. The method of claim 4, wherein said dissimilarity measure comprises a geodesic distance over said surface.

6. The method of claim 3, wherein said calculating said spectral representation comprises applying an optimization procedure to traces of matrices obtained by transformations of an eigenbasis matrix describing said eigenbasis by a spectral representation matrix describing said spectral representation.

7. The method according to claim 1, wherein said calculation of said a mapping matrix, comprises applying an optimization procedure to a trace of a matrix constructed from said mapping matrix and from spectral representation matrices describing said spectral representations of said first and said second surfaces.

8. The method according to claim 1, further comprising calculating said eigenbasis.

9. The method according to claim 1, wherein said eigenbasis matrix is a Laplacian eigenbasis.

10. The method according to claim 1, wherein said first and said second surfaces are surfaces of an organism at different poses.

11. The method according to claim 1, wherein said first and said second surfaces are surfaces of an organ of a human or an animal at different poses.

12. The method according to claim 1, wherein said first and said second surfaces are surfaces of macromolecules.

13. A computer software product, comprising a non-volatile computer-readable medium in which program instructions are stored, which instructions, when read by a data processor, cause the data processor to calculate, for each surface, a spectral representation based on an eigenbasis of at least a portion of said surface; to calculate a mapping matrix based on said spectral representations; to determine the correspondence between the non-planar surfaces, based on said mapping matrix and said eigenbases, and to display said correspondence and/or recording said correspondence on a non-volatile computer readable medium.

14. A system for determining correspondence between non-planar surfaces, the system comprising a data processor configured for receiving coordinates of said surfaces, for calculating, for each surface, a spectral representation based on an eigenbasis of at least a portion of said surface; for calculating a mapping matrix, based on said spectral representations; for determining the correspondence between the non-planar surfaces, based on said mapping matrix and said eigenbases, and for displaying said correspondence and/or recording said correspondence on a non-volatile computer readable medium.

15. The system of claim 14, wherein at least one of said non-planar surfaces is characterized by a dissimilarity matrix, and wherein said calculation of said spectral representation is also based on said dissimilarity matrix.

16. The system of claim 15, wherein said data processor is configured for calculating said dissimilarity matrix.

17. The system of claim 16, wherein said calculating said dissimilarity matrix comprises calculating a dissimilarity measure between every two points of said at least a portion of said surface.

18. The system of claim 17, wherein said dissimilarity measure comprises a geodesic distance over said surface.

19. The system of claim 16, wherein said calculating said spectral representation comprises applying an optimization procedure to traces of matrices obtained by transformations of an eigenbasis matrix describing said eigenbasis by a spectral representation matrix describing said spectral representation.

20. The system according to claim 14, wherein said calculation of said calculating a mapping matrix, comprises applying an optimization procedure to a trace of a matrix constructed from said mapping matrix and from spectral representation matrices describing said spectral representations of said first and said second surfaces.

21. The system according to claim 14, wherein said data processor is configured for calculating said eigenbasis.

22. The system according to claim 14, wherein said eigenbasis matrix is a Laplacian eigenbasis.
